(19) United States
(12) Patent Application Publication
(10) Pub. No.: US 2026/0011920 A1
(43) Pub. Date: Jan. 8, 2026

(54) ANTENNA PATTERN MANUFACTURING METHOD

(71) Applicant: AMOTECH CO., LTD., Namdong-gu, Incheon (KR)

(72) Inventors: Jooseung MAENG, Incheon (KR); Jinwon NOH, Incheon (KR)

(73) Assignee: AMOTECH CO., LTD., Namdong-gu, Incheon (KR)

(21) Appl. No.: 18/880,241

(22) PCT Filed: Jun. 22, 2023
(86) PCT No.: PCT/KR2023/008690

§ 371 Date: Dec. 30, 2024

(30) Foreign Application Priority Data
Jun. 28, 2022 (KR) 10-2022-0078586

(51) Int. Cl. H01Q 7/00; H01Q 1/22; H01Q 1/38

(52) U.S. Cl. CPC H01Q 7/00; H01Q 1/2208; H01Q 1/38

(57) ABSTRACT

The present disclosure presents an antenna pattern manufacturing method which, by forming a through hole in a metal sheet via a punching and an etching process, enables the precise formation of the line spacing of an antenna pattern. The presented antenna pattern manufacturing method comprises forming a first half groove in one surface of a metal sheet via a punching process and a second half groove in the other surface of the metal sheet via an etching process, wherein the first half groove and the second half groove at least partially overlap to form a through hole penetrating through the metal sheet.

### TECHNICAL FIELD

The present disclosure relates to an antenna pattern manufacturing method, and more specifically, to a method of manufacturing an antenna pattern with a loop shape mounted on a portable terminal or the like and used for wireless power transmission/reception or communication.

### BACKGROUND ART

Recently, the market demand for high-power wireless charging of 20 W or higher for high-speed charging is increasing. The high-power wireless charging may have reduced charging efficiency or, in severe cases, cause a fire because a high voltage is applied to a wireless power transmission/reception antenna and a substrate in comparison to general charging methods.

Accordingly, in the high-power wireless charging market, the importance of heat generation suppression as well as wireless charging efficiency is increasing, and the thickness of an antenna is increasing for charging efficiency and heat generation suppression.

A coil winding method, a pattern printing method, and a hybrid method are mainly used as a method of manufacturing a wireless power transmission/reception antenna.

However, conventional manufacturing methods cannot precisely form a line spacing (or a line width) of a pattern when the thickness of the antenna increases. Accordingly, antennas manufactured by the conventional manufacturing methods have a problem that heat generation can be suppressed but charging efficiency is lowered.

The matters described above in the background art are intended to help understanding of the background of the disclosure and may include matters not related to the known related art.

### SUMMARY OF INVENTION

### Technical Problem

The present disclosure has been proposed to solve the above problem and is directed to providing an antenna pattern manufacturing method of forming a through hole in a metal sheet through a punching process and an etching process and precisely forming a line spacing (or a line width) of an antenna pattern.

### Solution to Problem

To achieve the above object, an antenna pattern manufacturing method according to an embodiment of the present disclosure includes laminating a carrier sheet on a first surface of a metal sheet, punching a second surface of the metal sheet facing the first surface to form a first half groove recessed in an inward direction of the metal sheet from the second surface of the metal sheet, laminating a coverlay sheet on the second surface of the metal sheet in which the first half groove is formed, removing the carrier sheet formed on the first surface of the metal sheet, exposing the first surface of the metal sheet with the carrier sheet removed, and half-etching the first surface of the metal sheet to form a second half groove recessed in an inward direction of the metal sheet from the first surface of the metal sheet.

The forming of the second half groove may include forming the second half groove so that at least a part thereof overlaps the first half groove, and the first half groove and the second half groove may form a through hole passing through the first surface and the second surface of the metal sheet.

The through hole may form a line spacing of the antenna pattern, and the line spacing of the antenna pattern may be the same as a thickness of the metal sheet, or a width of the through hole may be 80% or more and 120% or less of a thickness of the metal sheet.

The first half groove may have a first center axis vertically passing through the first surface and the second surface of the metal sheet, and the second half groove has a second center axis vertically passing through the first surface and the second surface of the metal sheet, and the first center axis and the second center axis may be spaced apart from each other.

The metal sheet may be a plate-shaped substrate having a set thickness, and the set thickness may be 70 μm or more.

The antenna pattern manufacturing method according to the embodiment of the present disclosure may further include surface-treating the first surface of the metal sheet in which the second half groove is formed, wherein the surface-treating of the first surface of the metal sheet may include forming a rust-resisting film on the first surface of the metal sheet.

The antenna pattern manufacturing method according to the embodiment of the present disclosure may further include stamping the metal sheet in which the second half groove is formed to form an outline of the antenna pattern.

### Advantageous Effects of Invention

According to the present disclosure, the antenna pattern manufacturing method can form the through hole in the metal sheet by separately performing a punching process and an etching process, thereby reducing the line spacing and/or the line width by about 50% in comparison to the antenna pattern formed by the conventional antenna pattern manufacturing methods.

In addition, since the antenna pattern manufacturing method can reduce the width of the through hole (i.e., the line spacing or the line width of the antenna pattern) by about 50% in comparison to the conventional methods, the antenna pattern having the line spacing (pitch) of 100 μm or less can be manufactured even on the metal sheet having a thickness of 3 oz (105 μm) or more.

In addition, the antenna pattern manufacturing method can manufacture the antenna pattern having the line spacing of about 80% to 120% of the metal thickness, thereby increasing the degree of freedom of design and enabling the performance optimization design.

### BRIEF DESCRIPTION OF DRAWINGS

FIG. 1 is a view for describing an antenna pattern manufacturing method according to an embodiment of the present disclosure.

FIG. 2 is a view for describing an antenna pattern manufactured by the antenna pattern manufacturing method according to the embodiment of the present disclosure.

FIGS. 3 and 4 are views for describing a through hole illustrated in FIG. 2.

FIG. 5 is a view for describing a modified example of the through hole illustrated in FIG. 2.

FIG. 6 is a flowchart for describing the antenna pattern manufacturing method according to the embodiment of the present disclosure.

FIG. 7 is a view for describing each operation of the antenna pattern manufacturing method according to the embodiment of the present disclosure.

FIGS. 8 and 9 are views for describing a comparison between a conventional antenna pattern manufacturing method and the antenna pattern manufacturing method of the present disclosure.

### DESCRIPTION OF EMBODIMENTS

Hereinafter, exemplary embodiments according to the present disclosure will be described in detail with reference to the accompanying drawings.

The embodiments are provided to more completely describe the present disclosure to those skilled in the art, and the following embodiments may be modified in various different forms, and the scope of the present disclosure is limited to the following embodiments. Rather, the embodiments are provided to make the disclosure more faithful and complete and fully convey the spirit of the present disclosure.

Terms used herein are intended to describe specific embodiments and are not intended to limit the present disclosure. In addition, in the present specification, singular forms may include plural forms unless the context clearly indicates otherwise.

In the description of the embodiment, when each layer (film), area, pattern, or structure is described as being formed “on” or “under” a substrate, each layer (film), area, pad, or patterns, “on” and “under” include both cases of being formed “directly” or “indirectly with other elements interposed therebetween.” In addition, in principle, the reference for “above” or “under” each layer are based on the drawing.

The drawings are only intended to help understanding of the spirit of the present disclosure and should not be construed as limiting the scope of the present disclosure by the drawings. In addition, in the drawings, a relative thickness and length, or a relative size may be illustrated in an exaggeration manner for the sake of convenience and clarity of description.

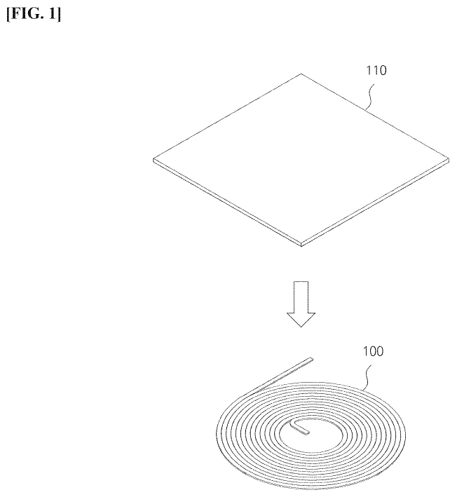

Referring to FIG. 1, an antenna pattern manufacturing method according to the embodiment of the present disclosure manufactures a loop-shaped antenna pattern 100 using a metal sheet 110. The antenna pattern 100 manufactured through the antenna pattern manufacturing method can be used as a wireless power transmission/reception (wireless power consortium (WPC)) antenna pattern, a near filed communication (NFC) antenna pattern, a magnetic secure transmission (MST) antenna pattern, and the like.

The antenna pattern manufacturing method according to the embodiment of the present disclosure may be used to manufacture a combo antenna pattern including two or more of the WPC, the NFC, and the MST.

In addition, one or more antenna patterns 100 manufactured by the antenna pattern manufacturing method according to the embodiment of the present disclosure may be assembled on a circuit board (flexible printed circuit board (FPCB)) to configure a single antenna or a combo antenna. In this case, the antenna pattern 100 may be assembled to the circuit board through a soldering process, an ultrasonic fusing process, etc.

In this case, at least one antenna pattern among the NFC antenna pattern and the MST antenna pattern, and terminal parts for connecting the antenna patterns to an external board (e.g., a main board of a portable terminal) may be formed on the circuit board, the WPC antenna pattern 100 manufactured by the antenna pattern manufacturing method according to the embodiment of the present disclosure may be assembled to the circuit board through a soldering process, a ultrasonic fusing process, or the like, and a shielding sheet, a heat-dissipation sheet, and the like may be assembled to configure a combo antenna.

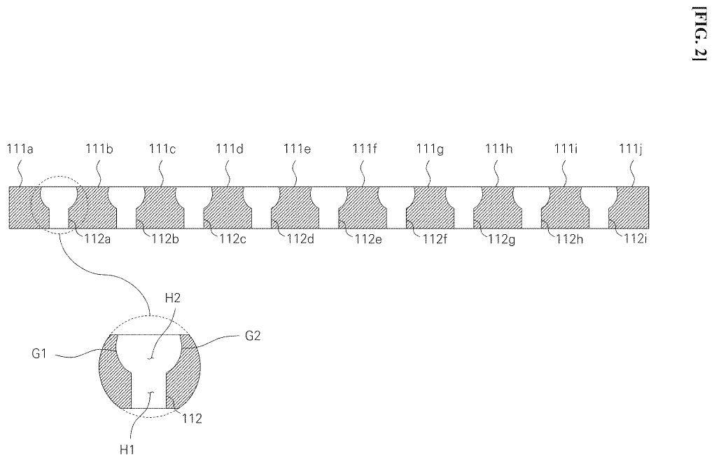

Referring to FIG. 2, a vertically cut surface of the antenna pattern 100 manufactured by the antenna pattern manufacturing method according to the embodiment of the present disclosure has a plurality of metal patterns 111a to 111j and a plurality of through holes 112a to 112i that are alternately disposed. To easily describe the antenna pattern 100 according to the embodiment of the present disclosure, the following description will be given based on the vertically cut surface of the antenna pattern 100.

A groove G is formed at an end portion of the metal pattern 111, which is adjacent to the through hole 112. In this case, the groove G may be formed only at an end portion of one of the two metal patterns 111 adjacent to both sides of the through hole 112.

For example, a first groove G1 may be formed at a first end portion of a first metal pattern 111a to be tilted upward from the first metal pattern 111a based on the drawing. A second groove G2 may be formed at a first end portion of a second metal pattern 111b to be tilted upward from the second metal pattern 111b based on the drawing. In this case, the first groove G1 and the second groove G2 are disposed to face each other.

Here, the groove G is illustrated and described as being formed in both the first metal pattern 111a and the second metal pattern 111b, but is not limited thereto, and the groove G may be formed only in a cross section of one of the first metal pattern 111a and the second metal pattern 111b.

The through hole 112 is interposed between two adjacent metal patterns 111 to form a separation space, and the separation space formed by the through hole 112 forms a line spacing of the antenna pattern 100. For example, a first through hole 112a is interposed between the first metal pattern 111a and the second metal pattern 111b to separate the first metal pattern 111a and the second metal pattern 111b. A second through hole 112b is interposed between the second metal pattern 111b and a third metal pattern 111c to separate the second metal pattern 111b and the third metal pattern 111c. Each of a third through hole 112b to a ninth through hole 112i is also interposed between two adjacent metal patterns 111 to separate the two metal patterns 111.

The through hole 112 includes a first half hole H1 and a second half hole H2. The first half hole H1 and the second half hole H2 are configured to at least partially overlap each other to form the through hole 112 that vertically passes through upper and lower surfaces of the antenna pattern 100. Here, the first half hole H1 and the second half hole H2 correspond to a first half groove 113 and a second half groove 114, which will be described below, respectively.

As an example, the first half hole H1 is formed through a punching process and thus is formed in a rectangular shape, and the second half hole H2 is formed through an etching process and thus is formed in a circular shape with upper and lower parts cut in the drawing.

The first half hole H1 may be formed in various shapes depending on a shape of a punching blade of a punching device, an entry angle of the punching blade, a strength of the metal sheet 110, or the like.

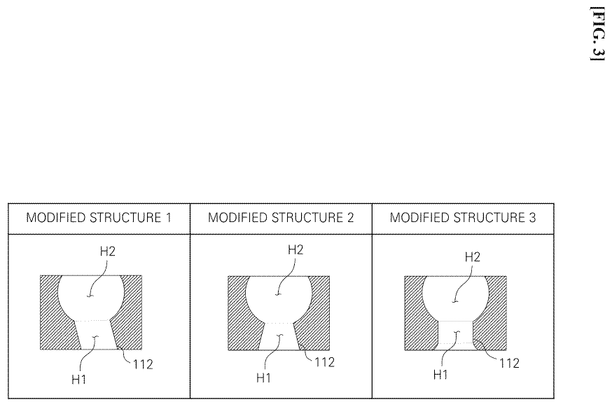

For example, referring to FIG. 3, the first half hole H1 may be formed in a parallelogram shape (see a deformation structure 1 of FIG. 3), a trapezoidal shape (see a deformation structure 2 of FIG. 3), a tapered rectangular shape (see a deformation structure 3 of FIG. 3), or the like.

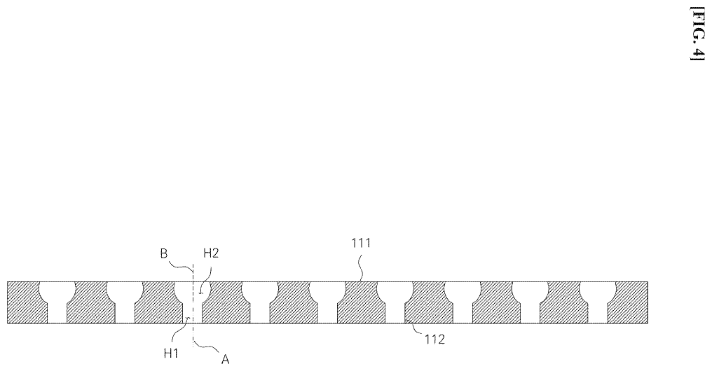

Referring to FIG. 4, a center axis A of the first half hole H1 and a center axis B of the second half hole H2 are orthogonal to the upper and lower surfaces of the antenna pattern 100, and the center axis A and the center axis B may be disposed colinearly.

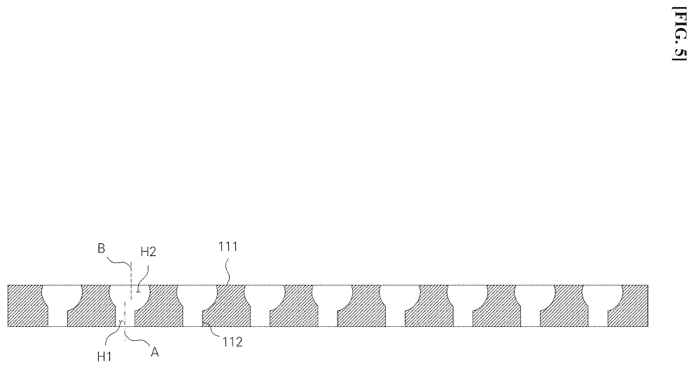

In the embodiment of the present disclosure, the through hole 112 is formed through a punching process and an etching process, but in an actual process, it is very difficult to etch the second half hole H2 to be precisely aligned with the first half hole H1. Accordingly, referring to FIG. 5, the first half hole H1 and the second half hole H2 may be formed to be misaligned.

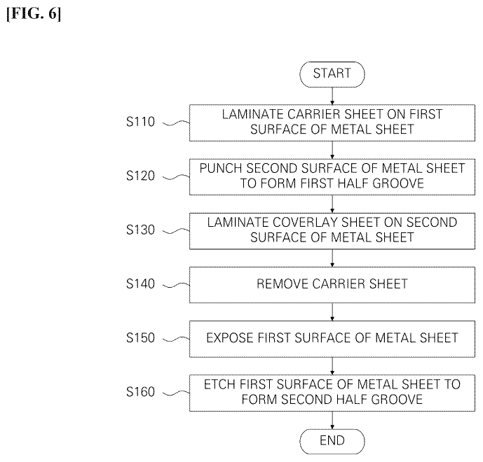

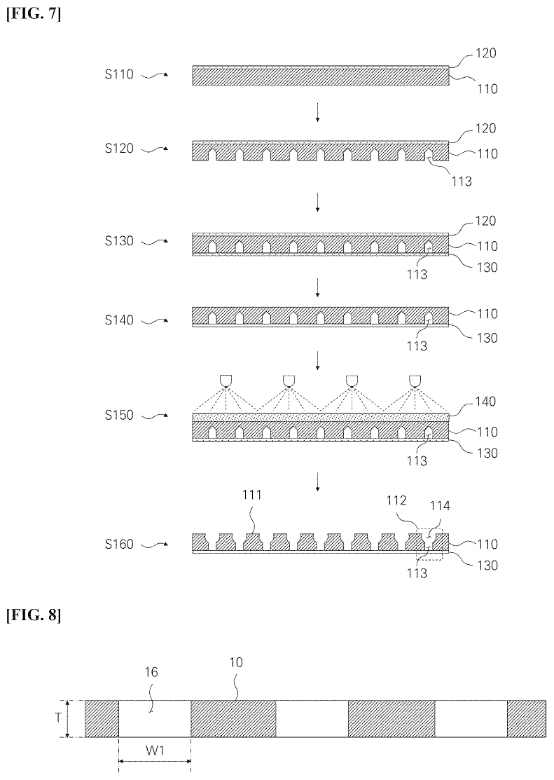

Referring to FIGS. 6 and 7, the antenna pattern manufacturing method according to the embodiment of the present disclosure includes a carrier sheet laminating operation S110, a first half groove forming operation S120, a coverlay sheet laminating operation S130, a carrier sheet removing operation S140, an exposing operation S150, and a second half groove forming operation S160.

The carrier sheet laminating operation S110 includes laminating a carrier sheet 120 on a first surface of the metal sheet 110. The carrier sheet laminating operation S110 includes laminating the carrier sheet 120 on the first surface of the metal sheet 110 (i.e., the upper surface of the metal sheet 110) having a thickness greater than or equal to a set thickness.

The carrier sheet laminating operation S110 includes preparing the metal sheet 110 having a thickness of about 2 oz (i.e., about 70 μm) or more. In this case, the carrier sheet laminating operation S110 includes preparing the metal sheet 110 formed of copper (Cu) used for the general antenna pattern 100.

The carrier sheet laminating operation S110 includes preparing the carrier sheet 120 formed of a polymer such as polyimide (PI), polyethylene terephthalate (PET), or the like, or a resin that is an amorphous solid or semi-solid formed of an organic compound and its derivative.

As an example, the carrier sheet laminating operation S110 includes laminating the carrier sheet 120 on the first surface of the metal sheet 110 through a roll-to-roll process.

The first half groove forming operation S120 includes half-punching a second surface of the metal sheet 110 to form the first half groove 113 in the second surface of the metal sheet 110. The first half groove forming operation S120 includes adjusting a punching pressure to form a plurality of first half grooves 113 in the second surface of the metal sheet 110.

The coverlay sheet laminating operation S130 includes laminating the coverlay sheet 130 on the second surface of the metal sheet 110 in which the first half groove 113 is formed. The coverlay sheet laminating operation S130 includes laminating the coverlay sheet 130 on the second surface of the metal sheet 110 in which the first half groove 113 is formed. In this case, the coverlay sheet 130 is, for example, a sheet formed of a material such as PI, PET, a thermosetting resin, or the like.

The carrier sheet removing operation S140 includes removing the carrier sheet 120 from the metal sheet 110 in which the coverlay sheet 130 is laminated on the first surface thereof. The carrier sheet removing operation S140 includes removing the carrier sheet 120 laminated on the second surface of the metal sheet 110.

The exposing operation S150 includes exposing the first surface of the metal sheet 110. The exposing operation S150 includes laminating an exposure film on the metal sheet 110 on which the carrier sheet 120 is laminated to form a photoresist layer 140 on the first surface of the metal sheet 110. In this case, the exposing operation S150 may include applying a photosensitive solution on the first surface of the metal sheet 110 to form the photoresist layer 140 on the first surface of the metal sheet 110.

In the exposing operation S150, UV light is radiated onto the first surface of the metal sheet 110 through the exposure device in a state in which an antenna pattern 100 mask is laminated (or disposed) on the first surface of the metal sheet 110 on which the photoresist layer 140 is formed. Accordingly, the photoresist layer 140 formed on the first surface of the metal sheet 110 is cured to the same shape as the antenna pattern 100 of the antenna pattern 100 mask.

The second half groove forming operation S160 includes etching the first surface of the metal sheet 110 to form the second half groove 114 in the metal sheet 110.

The second half groove forming operation S160 includes etching the first surface of the metal sheet 110 subjected to the exposing operation to form the second half groove 114 in the metal sheet 110.

The second half groove forming operation S160 includes etching the first surface of the metal sheet 110 on which the photoresist layer 140 is laminated. The second half groove forming operation S160 includes etching the first surface of the metal sheet 110 on which the photoresist layer 140 is laminated through an etching process such as wet etching, dry etching, or the like. Accordingly, the second half groove 114 recessed in an inward direction of the metal sheet 110 from the first surface of the metal sheet 110 is formed in the metal sheet 110.

In this case, the second half groove forming operation S160 includes forming the second half groove 114 to overlap at least a part of the first half groove 113 formed in the first half groove forming operation S120. Accordingly, the first half groove 113 and the second half groove 114 form the through hole 112 passing through the metal sheet 110, and the through hole 112 forms the line spacing of the antenna pattern 100 formed by the metal sheet 110.

The second half groove forming operation S160 includes removing the cured photoresist layer 140 after forming the second half groove 114.

Referring to FIG. 8, the conventional antenna pattern manufacturing method includes forming a through hole 11 forming a line spacing of an antenna pattern 100 in a metal sheet 10 through one etching. In this case, due to the limitation of the etching technology, a width W1 of the through hole 11 increases in proportion to a thickness T of the metal sheet 10, and the width W1 of the through hole 11 (i.e., the line spacing of the antenna pattern) formed through the conventional etching process is formed to be about twice (200%) the thickness T of the metal sheet 10.

That is, when the thickness T of the metal sheet 10 (the antenna pattern) is about 2 oz (about 70 μm), the width W1 of the through hole 11 (i.e., the line spacing or line width of the antenna pattern) formed through the conventional antenna pattern manufacturing method is formed to be about 140 μm.

When the thickness T of the metal sheet 10 (the antenna pattern 100) is about 3 oz (about 105 μm), the width W1 of the through hole 11 (i.e., the line spacing or line width of the antenna pattern) formed by the conventional antenna pattern manufacturing method is formed to be about 210 μm.

In contrast, the antenna pattern manufacturing method according to the embodiment of the present invention separately performs a punching process and an etching process to form the through hole 112 so that the width of the through hole 112 (i.e., the line spacing or line width of the antenna pattern 100) formed in the metal sheet 110 may be formed to be less than or equal to the thickness of the metal sheet 110.

In this case, the width of the through hole 112 (i.e., the line spacing or line width of the antenna pattern 100) may be formed to range from about 80% to 120% of the thickness of the metal sheet 110 in addition to errors in the manufacturing process.

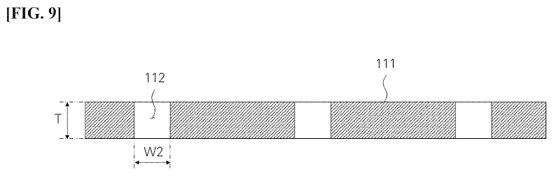

For example, referring to FIG. 9, when the thickness T of the metal sheet 110 (i.e., the antenna pattern 100) is about 2 oz (about 70 μm), a width W2 of the through hole 112 (i.e., the line spacing or line width of the antenna pattern 100) manufactured by the antenna pattern manufacturing method according to the embodiment of the present disclosure is formed to be about 70 μm.

When the thickness T of the metal sheet 110 (the antenna pattern 100) is about 3 oz (about 105 μm), the width W2 (i.e., the line spacing or line width of the antenna pattern) of the through hole 112 formed by the conventional antenna pattern manufacturing method is formed to be about 100 μm.

In this way, the antenna pattern manufacturing method according to the embodiment of the present disclosure may manufacture the antenna pattern 100 having the line spacing of 80% or more and 120% or less of the thickness of the metal sheet 110 with a simple process by forming the second half groove 114 through the punching process and the etching process. That is, the antenna pattern manufacturing method according to the embodiment of the present disclosure may form the first half groove 113 through the punching process and the second half groove 114 through the etching process, thereby reducing the width of the through hole 112 formed in the metal sheet 110 (i.e., the line spacing or line width of the antenna pattern 100) by about 50% in comparison to the conventional antenna pattern manufacturing method.

In addition, according to the antenna pattern manufacturing method according to the embodiment of the present disclosure, it is possible to reduce the width of the through hole 112 (i.e., the line spacing or line width of the antenna pattern 100) by about 50% in comparison to the conventional method, thereby manufacturing the antenna pattern 100 having the line spacing (pitch) of 100 μm or less even in the metal sheet 110 having a thickness of 3 oz (105 μm) or more.

In addition, according to the antenna pattern manufacturing method, it is possible to manufacture the antenna pattern 100 having the line spacing of about 80% to 120% of the thickness of the metal, thereby increasing the degree of freedom of design and enabling the performance optimization design.

Although not illustrated in FIGS. 6 and 7, the antenna pattern manufacturing method according to the embodiment of the present disclosure may further include a surface treating operation and a stamping operation that are performed gradually after the second half groove forming operation S160.

The surface treating operation includes surface-treating the first surface of the metal sheet 110. The surface treating operation includes applying an organic material through an organic solderability preservative (OSP) process to form a rust-resisting film 118 on the first surface of the metal sheet 110. Accordingly, the first surface of the metal sheet 110 is planarized, and contact between the metal sheet 110 and air is blocked, thereby preventing oxidation of the metal sheet 110 (i.e., the antenna pattern 100). In the surface treating operation, to prevent oxidation of the metal sheet 110 along with the OSP process, a plating layer may be formed by plating the first surface of the metal sheet 110 with tin (Sn) and nickel (Ni).

The stamping operation includes forming an outline of the antenna pattern 100 on the metal sheet 110 through a stamping process. The stamping operation includes stamping the metal sheet 110 through a stamping device and forming the outline of the antenna pattern 100.

Through the above-described processes, the antenna pattern manufacturing method according to the embodiment of the present disclosure may manufacture the antenna pattern 100 having a line spacing of 80% or more and 120% or less of the thickness of the metal sheet 110. The antenna pattern 100 manufactured by the above-described processes may operate as a WPC antenna, an NFC antenna, an MST antenna, or the like.

The above description is merely the exemplary description of the technical spirit of the present disclosure, and those skilled in the art to which the present disclosure pertains will be able to variously modify and change the present disclosure without departing from the essential characteristics of the present disclosure. Therefore, the embodiments disclosed in the present disclosure are not intended to limit the technical spirit of the present disclosure, but intended to describe the same, and the scope of the technical spirit of the present disclosure is not limited by these embodiments. The scope of the present disclosure should be construed by the appended claims, and all technical ideas within the equivalent scope should be construed as being included in the scope of the present disclosure.

1. An antenna pattern manufacturing method comprising:
laminating a carrier sheet on a first surface of a metal sheet;
punching a second surface of the metal sheet facing the first surface to form a first half groove recessed in an inward direction of the metal sheet from the second surface of the metal sheet;
laminating a coverlay sheet on the second surface of the metal sheet in which the first half groove is formed;
removing the carrier sheet formed on the first surface of the metal sheet;
exposing the first surface of the metal sheet with the carrier sheet removed; and
half-etching the first surface of the metal sheet to form a second half groove recessed in an inward direction of the metal sheet from the first surface of the metal sheet.

2. The antenna pattern manufacturing method of claim 1, wherein the forming of the second half groove includes forming the second half groove so that at least a part thereof overlaps the first half groove, and
the first half groove and the second half groove form a through hole passing through the first surface and the second surface of the metal sheet.

3. The antenna pattern manufacturing method of claim 2, wherein the through hole forms a line spacing of the antenna pattern, and the line spacing of the antenna pattern is the same as a thickness of the metal sheet.

4. The antenna pattern manufacturing method of claim 2, wherein a width of the through hole is 80% or more and 120% or less of a thickness of the metal sheet.

5. The antenna pattern manufacturing method of claim 1, wherein the first half groove has a first center axis vertically passing through the first surface and the second surface of the metal sheet, and the second half groove has a second center axis vertically passing through the first surface and the second surface of the metal sheet, and
the first center axis and the second center axis are spaced apart from each other.

6. The antenna pattern manufacturing method of claim 1, wherein the first half groove has a first center axis vertically passing through the first surface and the second surface of the metal sheet, and the second half groove has a second center axis vertically passing through the first surface and the second surface of the metal sheet, and
the first center axis and the second center axis are disposed colinearly.

7. The antenna pattern manufacturing method of claim 1, wherein the metal sheet is a plate-shaped substrate having a set thickness, and
the set thickness is 70 μm or more.

8. The antenna pattern manufacturing method of claim 1, further comprising surface-treating the first surface of the metal sheet in which the second half groove is formed,
wherein the surface-treating of the first surface of the metal sheet includes forming a rust-resisting film on the first surface of the metal sheet.

9. The antenna pattern manufacturing method of claim 1, further comprising stamping the metal sheet in which the second half groove is formed to form an outline of the antenna pattern.
